(19) United States
(12) Patent Application Publication
(10) Pub. No.: US 2016/0309954 A1
(43) Pub. Date: Oct. 27, 2016

(54) SYSTEM AND METHOD FOR REMOTELY CONTROLLING A FOOD PREPARING APPLIANCE

(71) Applicant: COMIGO LTD., Yarkona (IL)

(72) Inventors: Motty LENTZITZKY, Tel Aviv (IL); Yoav GAZIEL, Tel Aviv (IL); Avraham MAKOVETSKY, Bnei-Brak (IL)

(21) Appl. No.: 15/203,836

(22) Filed: Jul. 7, 2016

Related U.S. Application Data
(63) Continuation-in-part of application No. 13/804,545, filed on Mar. 14, 2013.
(60) Provisional application No. 62/191,423, filed on Jul. 12, 2015.
(60) Provisional application No. 61/643,372, filed on May 7, 2012.
(60) Provisional application No. 61/643,375, filed on May 7, 2012.
(60) Provisional application No. 61/611,024, filed on Mar. 15, 2012.
(60) Provisional application No. 61/611,030, filed on Mar. 15, 2012.

(51) Int. Cl. A47J 36/32; G06F 17/30; G05B 11/01; G05B 19/04; G05B 15/02

(52) U.S. Cl. CPC A47J 36/32; G05B 19/0415; G05B 15/02; G05B 11/01; G06F 17/30044; G05B 2219/2613

(57) ABSTRACT

A device and a method for remotely controlling a food preparing appliance to prepare a food product at a time related to an event in a media content item.

### RELATED APPLICATION

The present application gains priority from U.S. Provisional Patent Application 62/191,423 filed Jul. 12, 2015 and entitled “Controlling A Food-Preparing Appliance”, and is a Continuation In Part of U.S. patent application Ser. No. 13/804,545 filed Mar. 14, 2013 and entitled “System and Method for Social Television Management of Smart Homes”, which in turn claims the benefit of U.S. Provisional Patent Application 61/611,024 filed Mar. 15, 2012, U.S. Provisional Patent Application 61/611,030 filed Mar. 15, 2012, U.S. Provisional Patent Application 61/643,372 filed May 7, 2012, and U.S. Provisional Patent Application 61/643,375 filed May 7, 2012, all of which are incorporated herein by reference as if fully set forth herein.

### FIELD AND BACKGROUND OF THE INVENTION

The invention, in some embodiments, relates to the field of smart electronic appliances, and more particularly to a system and method for remotely controlling a food-preparing appliance, specifically with respect to an event relating to media content displayed by a media content playing device.

In recent years, the concept of “Internet of Things” (IoT) has become increasingly popular. In the world envisioned by supporters of IoT, many, if not all, devices and appliances in one's environment, be it home or office, are computerized and are interconnected in a suitable network. As such, components of the network may communicate their status to other components of the network, may generate commands for remotely controlling other components of the network, and may receive remotely generated commands for control of their own functionality.

An important group of home appliances are appliances that prepare food, drinks, or an ingredient of a food or drink, herein referred to as “food-preparing appliances”. Examples are a coffee machine, a water boiler (such as a kettle), a popcorn machine, an oven, a stove, a microwave oven, a bread toaster, and the like. All such devices use raw materials, such as cold water, coffee beans, or popcorn kernels, to prepare a desired food product, such as boiled water, coffee, toasted bread, or popcorn. The preparation of the food product usually takes a certain amount of time, which may be dependent on the device, on the state of the raw ingredients used, on the specific food product being prepared, and/or on the ambient environment.

In typical use, the user must access a food preparing appliance in order to load raw materials and activate the appliance, and then access the food preparing appliance again in order to retrieve the prepared food product. Often, when the user engages a media content playing device by watching media content played thereon, the user wishes to eat or drink. Typically, the user waits for a break in the media content, such as a commercial break, then proceeds to activate the food preparing appliance. Subsequently, the user must wait until the prepared food product is ready and only then retrieve the prepared food product from the food preparing appliance, at which point the media content may have resumed. As such, from the user's perspective, the commercial break is not effectively utilized.

There is thus a need for a system and method which will electronically activate the food preparing appliance so that the desired food product is ready at a time corresponding to a break in the played media content or to another desired event in the played media content.

### SUMMARY OF THE INVENTION

Some embodiments of the invention relate to systems and methods for remotely controlling a food-preparing appliance, specifically with respect to an event relating to media content displayed by a media content playing device.

According to an aspect of some embodiments of the invention, in a system including a control module in communication with a media content playing device and with a food-preparing appliance operable to prepare a food product, there is provided a method for controlling the food-preparing appliance comprising the steps of:
a. obtaining, by communication between the control module and the media content playing device, a time of an event related to media content played by the media content playing device;
b. electronically determining by the control module a product readiness time for the food product based at least on the time of the event;
c. setting the food preparing appliance to begin operation at a time such that the food product be ready at the product readiness time.

In some embodiments, the setting includes, based on the product readiness time, computing a starting time at which the food-preparing appliance should begin operation, and setting the food-preparing appliance to begin operation at the starting time.

In some embodiments, setting the food-preparing appliance to begin operation at the starting time includes sending a command, from the control module to the food-preparing appliance, the command causing the food-preparing appliance to start operation at the starting time. In some embodiments, sending the command takes place immediately following computing the starting time. In some embodiments, sending the command takes place immediately prior to the starting time.

In some embodiments, computing the starting time comprises computing the starting time to be substantially equal to the time of the event. In some embodiments, computing the starting time comprises computing the starting time to be later than the time of the event by a predetermined delay duration. In some embodiments, computing the starting time comprises computing the starting time to be earlier than the time of the event by a predetermined preceding duration.

In some embodiments, the obtaining includes receiving from the media content playing device information relating to the media content, and determining the time of the event based on the received information.

In some embodiments, the determining comprises determining the product readiness time based on the time of the event and on previously stored user preferences accessible to the control module.

In some embodiments, the determining comprises determining the product readiness time to be substantially equal to the time of the event. In some embodiments, the determining comprises determining the product readiness time to be later than the time of the event by a predetermined delay duration. In some embodiments, the determining comprises determining the product readiness time to be earlier than the time of the event by a predetermined preceding duration.

In some embodiments, obtaining the time of the event takes place subsequently to occurrence of the event. In some embodiments, obtaining the time of the event takes place before occurrence of the event.

In some embodiments, the event is related to a media content item forming part of the media content, and is selected from the group consisting of:
a. a beginning of playing of the media content item;
b. an ending of playing the media content item;
c. pausing playing of the media content item;
d. resuming playing the media content item following pausing thereof;
e. starting playing advertisements during the media content item;
f. stopping playing advertisements during the media content item;
g. appearance of at least one of a specific actor, actress, character, or location in the media content item;
h. switching between scenes within the media content item;
i. starting a song in a soundtrack of the media content item;
j. ending a song in the soundtrack of the media content item;
k. starting a break in a sports game forming the media content item; and
l. ending a break in the sports game forming the media content item.

In some embodiments, the event is related to a media content item forming part of the media content, the media content item being played at a time of the obtaining the time of the event. In some embodiments, the event is related to a media content item forming part of the media content, wherein the media content item is scheduled to be played at a time following a time of the obtaining the time of the event.

In accordance with another aspect of some embodiments of the invention, there is provided a device for controlling a food preparing appliance, the device being in communication with the food preparing appliance and with a media content playing device, the device including:
a. a processor; and
b. a non-transitory computer readable storage medium for instructions execution by the processor, the non-transitory computer readable storage medium having stored:
   i. instructions to obtain, by communication with the media content playing device, a time of an event related to media content played by the media content playing device;
   ii. instructions to electronically determine a product readiness time for a food product based at least on the time of the event; and
   iii. instructions to set the food preparing appliance to begin operation at a time such that the food product be ready at the product readiness time.

In some embodiments, the device is further in communication with a non-transitory computer readable storage medium having user preferences stored therein, the non-transitory computer readable storage medium having stored instructions to determine the product readiness time based on the time of the event and on the user preferences.

In some embodiments, the non-transitory computer readable storage medium having stored instructions to compute, based on the product readiness time, a starting time at which the food-preparing appliance should begin operation and instructions to set the food preparing appliance to begin operation at the starting time.

In some embodiments, the instructions to set the food preparing appliance to begin operation at the starting time include instructions for sending a command to the food preparing appliance, the command causing the food preparing appliance to begin operation at the starting time.

In some embodiments, the instructions for sending a command include instructions for sending the command immediately following computing the starting time. In some embodiments, the instructions for sending a command include instructions for sending the command immediately prior to the starting time.

In some embodiments, the instructions for computing the starting time include instructions for computing the starting time to be immediately following the time of the event. In some embodiments, the instructions for computing the starting time include instructions for computing the starting time to be later than the time of the event by a predetermined delay duration. In some embodiments, the instructions for computing the starting time include instructions for computing the starting time to be earlier than the time of the event by a predetermined preceding duration.

In some embodiments, the instructions to obtain the time of the event include instruction to receive, from the media content playing device, information relating to the media content, and instructions to determine the time of the event based on the received information. In some embodiments, the instructions to obtain the time of the event are carried out subsequently to occurrence of the event. In some embodiments, the instruction to obtain the time of the event take place before occurrence of the event.

In some embodiments, the instructions to electronically determine the product readiness time include instructions to determine the product readiness time to be substantially equal to the time of the event. In some embodiments, the instructions to electronically determine the product readiness time include instructions to determine the product readiness time to be later than the time of the event by a predetermined delay duration. In some embodiments, the instructions to electronically determine the product readiness time include instructions to determine the product readiness time to be earlier than the time of the event by a predetermined preceding duration.

Unless otherwise defined, all technical and scientific terms used herein have the same meaning as commonly understood by one of ordinary skill in the art to which the invention pertains. In case of conflict, the specification, including definitions, will take precedence.

As used herein, the terms “comprising”, “including”, “having” and grammatical variants thereof are to be taken as specifying the stated features, integers, steps or components but do not preclude the addition of one or more additional features, integers, steps, components or groups thereof. These terms encompass the terms “consisting of” and “consisting essentially of”.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. Throughout the drawings, like-referenced characters are used to designate like elements.

In the drawings:

FIG. 1 is a schematic block diagram of a device for remotely controlling a food preparing appliance according to an embodiment of the teachings herein;

FIG. 2 is a schematic block diagram of a system for remotely controlling a food preparing appliance, the system including the device of FIG. 1, according to an embodiment of the teachings herein;

FIG. 3 is a flow chart of an embodiment of a method for controlling a food preparing appliance using a suitable device and system, such as the device of FIG. 1 and the system of FIG. 2, according to an embodiment of the teachings herein; and

FIGS. 4A and 4B are schematic pictorial illustrations of steps of use of a device for remotely controlling a food preparing appliance using the method of FIG. 3, according to an embodiment of the teachings herein.

### DESCRIPTION OF SOME EMBODIMENTS OF THE INVENTION

The invention, in some embodiments, relates to the field of smart electronic appliances, and more particularly to a system and method for remotely controlling a food-preparing appliance, specifically with respect to an event relating to media content displayed by a media content playing device.

In the context of the present application, the term “media content” relates to audio content, visual content, or combined audio-visual content (e.g., a movie including a sound track).

In the context of the present application, the term “media content item” relates to a segment of media content that can be uniquely identified, such as a movie, a scene from a movie, a video clip, a television program, a scene from a television program, a news report, a news item within a news report, a radio program, a sound track, or a specific song within a radio program or sound track.

In the context of the present application, the term “media content playing device” relates to a device suitable for playing media content, including a visual interface such as a screen for displaying visual content and/or an audio interface such as speakers or earphones for playing audio content.

In the context of the present application the term “watching media content”, and conjugations thereof, relates to watching media content having a visual component displayed on a visual interface such as a screen, listening to media content having an audio component played through an audio interface such as a speaker or earphones, or doing both concurrently.

In the context of the present application, the term “food product” relates to a food or a beverage, or an ingredient used for preparation of a food or a beverage, such as boiled water used for preparation of hot drinks.

In the context of the present application, the term “food preparing appliance” relates to an appliance used to prepare a food product or a beverage from one or more raw materials, such as a coffee machine, a popcorn maker, a microwave, and the like, or to an appliance used to prepare an ingredient for preparation of a food product or beverage, such as a kettle which prepares boiled water for preparation of hot drinks.

In the context of the teachings herein, the term “event related to media content” relates to an event related to the playing of a media content item or to the content of a media content item, such as starting playing the media content item, ending playing the media content item, pausing playing the media content item, resuming playing the media content item following pausing thereof, starting playing advertisements during the media content item, stopping playing advertisements during the media content item, appearance of a specific actor, actress, character, or location in the media content item, switching between scenes within the media content item, starting a song in a soundtrack of the media content item, ending a song in the soundtrack of the media content item, starting a specific segment in a soundtrack of the media content item, starting a break in a sports game forming the media content item, or ending a break in a sports game forming the media content item.

In the context of the present application, the term “product readiness time” relates to a time at which the food product prepared by a food preparing appliance should be ready for use by a user, or for consumption thereby.

In the context of the present application the term “electronically determining”, and conjugations thereof, relates to a determination action carried out by a machine or electronic module, either independently or based on input received directly from one or more other machines or electronic modules, without direct or immediate human intervention or input. An electronic determination may be based on user preferences provided by the user at an earlier stage, such as during setup, but is not conditioned on user input provided during the determination.

In the context of the present application, the term “A is immediately prior to B”, with respect to two occurrences (actions or events) A and B, relates to an occurrence A occurring within 10 seconds of occurrence B, and prior thereto.

In the context of the present application, the term “A is immediately following B”, with respect to two occurrences (actions or events) A and B, relates to an occurrence A occurring within 10 seconds of occurrence B, and subsequently thereto.

In the context of the teachings herein, the term “substantially equal”, in the context of time, relates to two times that are within 10 seconds of one another.

In the context of the teachings herein, the term “substantially equal”, in the context of quantity or magnitude, relates to two quantities or magnitudes that are within 1% of one another.

The principles, uses and implementations of the teachings herein may be better understood with reference to the accompanying description and figures. Upon perusal of the description and figures present herein, one skilled in the art is able to implement the invention without undue effort or experimentation.

Before explaining at least one embodiment of the invention in detail, it is to be understood that the invention is not limited in its applications to the details of construction and the arrangement of the components and/or methods set forth in the following description and/or illustrated in the drawings and/or the Examples. The invention can be implemented with other embodiments and can be practiced or carried out in various ways. It is also understood that the phraseology and terminology employed herein is for descriptive purpose and should not be regarded as limiting.

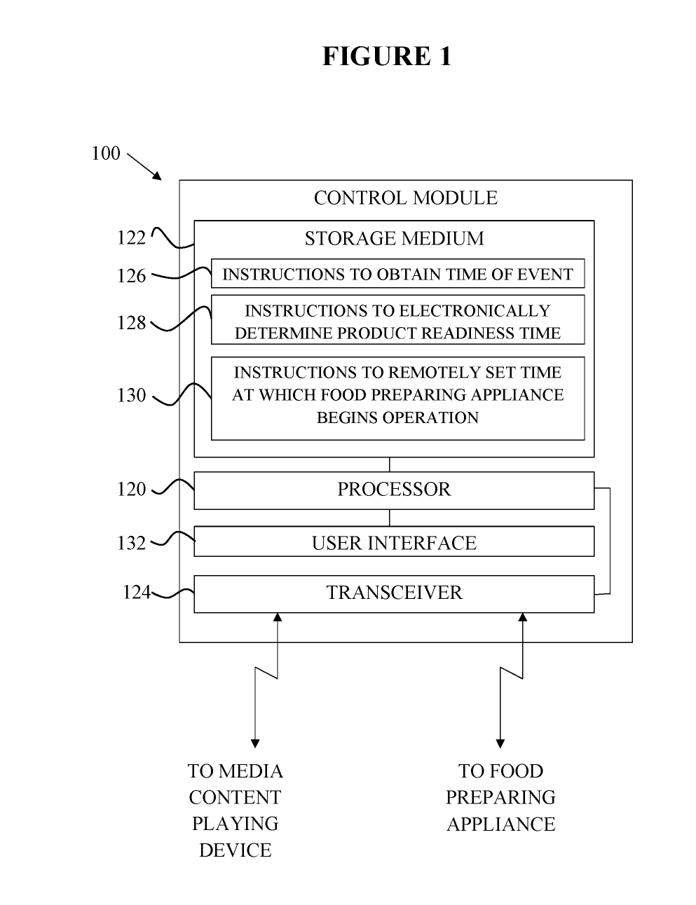

Reference is now made to FIG. 1, which is a schematic block diagram of a device for remotely controlling a food preparing appliance according to an embodiment of the teachings herein.

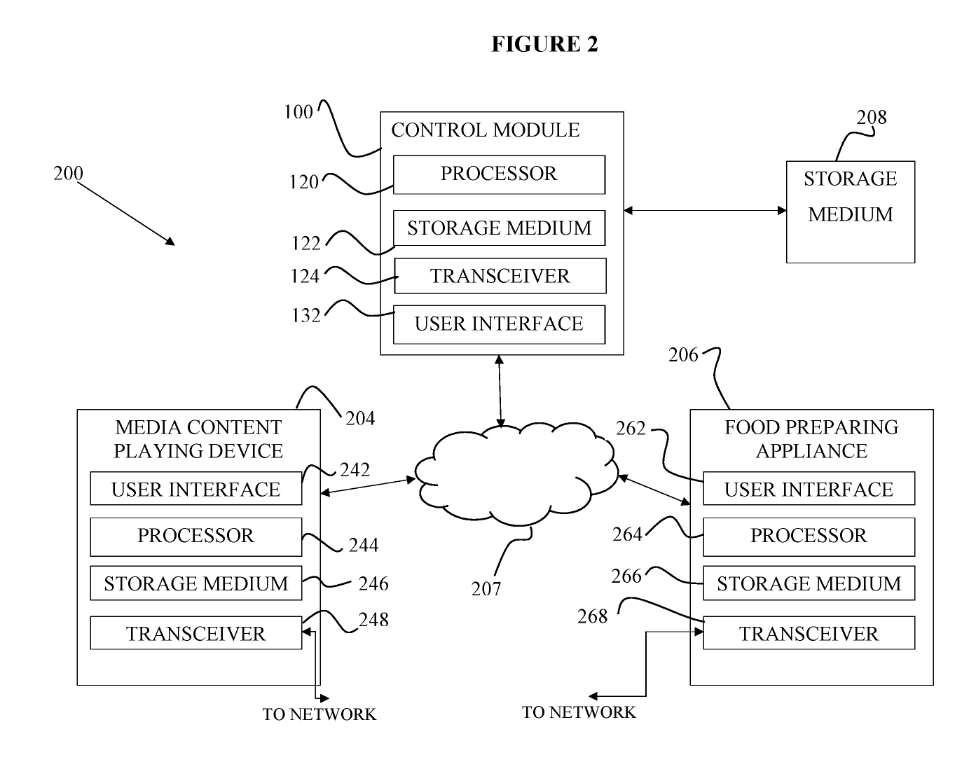

As seen in FIG. 1, a device 100 for remotely controlling a food preparing appliance (also referred to herein as control module 100), includes a processor 120 and a storage medium 122, which is typically a non-transitory computer readable storage medium. Processor 120 is further associated with a communication component, such as a transceiver 124, for communication with at least one media content playing device, with at least one food preparing device, and/or with at least one external storage medium, as described in further detail hereinbelow with reference to FIG. 2.

The storage medium 122 includes instructions to be executed by the processor 120, in order to carry out various steps of the method described herein, as described in further detail hereinbelow. Specifically, the storage medium includes at least:

instructions 126 to obtain, via communication with the media content playing device, a time of an event related to media content played by the media content playing device;

instructions 128 to electronically determine a product readiness time for a food product based at least on the time of the event; and

instructions 130 to remotely set the food preparing appliance to begin operation at a time such that the food product be ready at the product readiness time.

In some embodiments, the storage medium 122 may further include additional data usable by control module 100, such as control module and/or system settings, user preferences for the control module 100, and the like. In some embodiments, control module 100 may comprise, or form part of, a computer system for controlling a computerized or smart house or office.

In some embodiments, control module 100 may include a user interface 132, enabling the user to provide input to the control module and/or to receive output from the control module. The user interface may be a visual interface, such as a display screen, an audio interface, such as earphones or one or more speakers, or may be an input interface, such as a keyboard, a touch pad, a touch screen, a microphone, a mouse, or any other suitable input interface.

Reference is now made to FIG. 2, which is a schematic block diagram of a system 200 for remotely controlling a food preparing appliance according to an embodiment of the teachings herein, the system including a device 100 as described hereinabove with reference to FIG. 1.

As seen in FIG. 2, system 200 includes a device 100 for remotely controlling a food preparing appliance, for example as described hereinabove with reference to FIG. 1, which device is referred to herein as the control module. The system 200 further includes at least one media content playing device 204, and at least one food preparing appliance 206. For brevity, the following description relates to a single media content playing device 204 and to a single food preparing appliance 206, though it will be readily appreciated by ones of skill in the art that the teachings herein may be extended to relate to multiple media content playing devices and/or to multiple food preparing appliances.

Control module 100, media content playing device 204, and food preparing appliance 206 together form a network 207, or are part of a network, such that control module 100 is communicably connected to media content playing device 204 and to the food preparing appliance 206. The network 207 interconnecting control module 100, media content playing device 204 and food preparing appliance 206 may be a local area network (LAN), such as an Ethernet or an IEEE 802.2 or an IEEE 802.11 network, may be a wide area network (WAN), or may form part of the Internet, and may be wired or wireless. Communication between control module 100 and media content playing device 204, and between control module 100 and food preparing appliance 206, within the network 207, may be in accordance with any electronic communication protocol suitable for remote communication between two electronic devices, such as HTTP, FTP, and the like.

As discussed hereinabove with respect to FIG. 1, control module 100 includes a processor 120, a storage medium 122, a transceiver 124, and a user interface 132.

In some embodiments, the control module 100 my form part of the media content playing device 204, such as for example part of a Set Top Box (STB) or of the control mechanism of a smart television. In some embodiments, the control module 100 may form part of a handheld media content playing device, such as a smartphone or a tablet computer, adapted to communicate with a main media content playing device 204 on which the user watches media content.

Media content playing device 204 may be any suitable media content playing device, such as a television, a radio set, a laptop computer, a desktop computer, a gaming console, or the like. In some embodiments, media content playing device 204 is functionally associated with a user interface 242, which may include an audio interface such as earphone or one or more speakers, and/or a visual interface, such as a display screen. In some embodiments, the media content playing device further includes a dedicated processor 244, and/or a storage medium 246, which may be a non-transitory computer readable storage medium. Storage medium 246 may include data relating to media content and/or media content items to be played by the media content playing device 204, device settings, user preferences, and the like.

In some embodiments, the media content playing device 204 is communicably connected to another network, other than network 207, for example via a transceiver 248 associated therewith. The additional network may be, for example, a cable television network, a satellite based television network, or the Internet, and may be used for receiving networked media content, scheduling information, and the like.

Food preparing appliance 206 may be any suitable food preparing appliance, such as a water heater, a coffee machine, a popcorn machine, a microwave, an oven, an electric stove, a bread toaster, a crockpot, a bread baking machine, or the like. The food preparing appliance is adapted to use raw materials input thereinto by the user or automatically pulled-in by the food preparing appliance, and, following operation thereof, to provide a ready food product, such as boiled water, coffee, popcorn, toast, or the like.

In some embodiments, food preparing appliance 206 is functionally associated with a user interface 262, which may include a visual interface, such as a display screen, and/or an audio interface, such as a speaker for providing a beeping or whistling sound when the food product is ready. User interface 262 may also include an input mechanism such as a keypad or buttons interface. In some embodiments, the food preparing appliance further includes a dedicated processor 264, which may be adapted to operate the food preparation functionality of the appliance, such as the setting of duration, temperature, programs for different food products and the like, to determine the quantity of raw material in the appliance, and/or to notify the user, via user interface 262, that the raw materials in the appliance need to be refilled. In some embodiments, the determination of the quantity of raw materials in the appliance is based on signals received from one or more sensors (not shown) associated with the processor 264. In some embodiments, the food preparing appliance may be further associated with a storage medium 266, which may be a non-transitory computer readable storage medium, and which may include data relating to types of food products, recipes or instructions for preparation of specific food products, device settings, user preferences, and the like.

In some embodiments, the food preparing appliance 206 is communicably connected to an additional network, other than network 207, such as the Internet, for example via a transceiver 268 associated therewith. The additional network connection may be used for communication with a manufacturer, for example for receipt of software updates for the processor 264 and/or for reporting problems to the manufacturer or to a maintenance service.

In some embodiments, the control module 100 is further associated with an external storage medium 208, which may be a non-transitory computer readable storage medium such as a storage unit of a server or a database. Storage medium 208 may include data relating to network settings for network 207, as well as information relating to settings and/or user preferences relating to control module 100, media content playing device 204, food preparing appliance 206, or any other component of network 207. Storage medium 208 may be local to network 207, or may be remote therefrom, such as being located in a remote server or in a Cloud network.

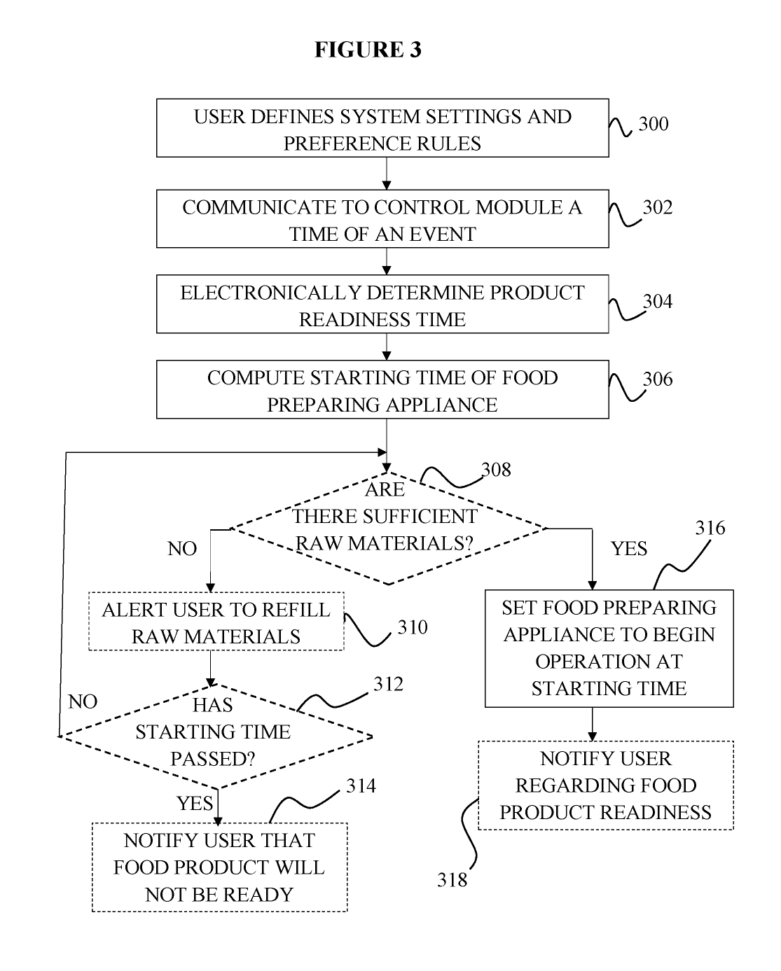

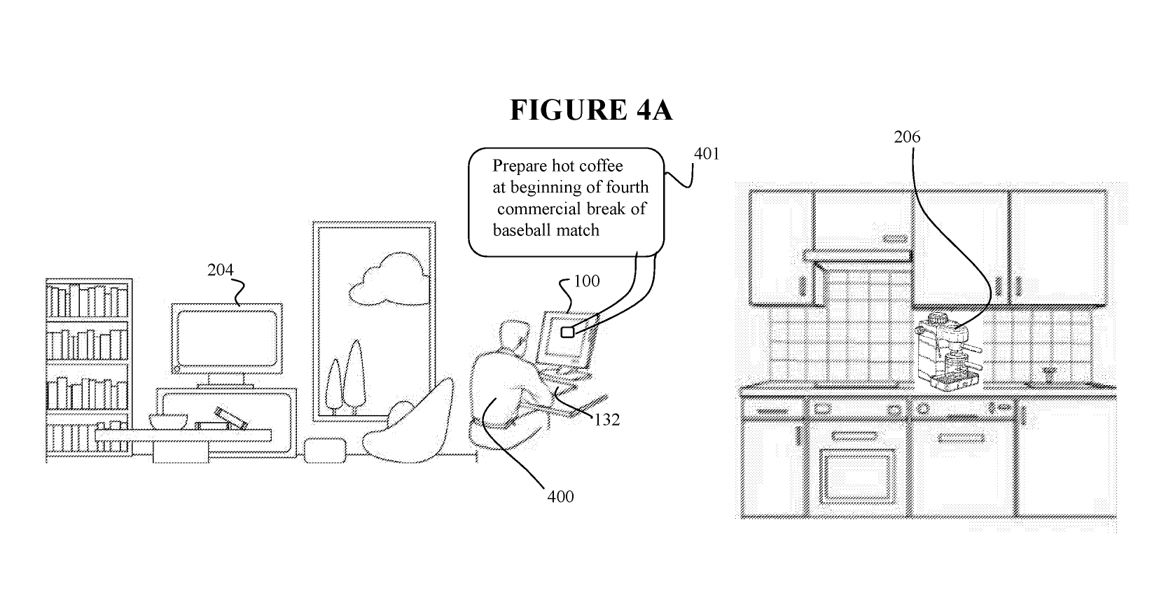

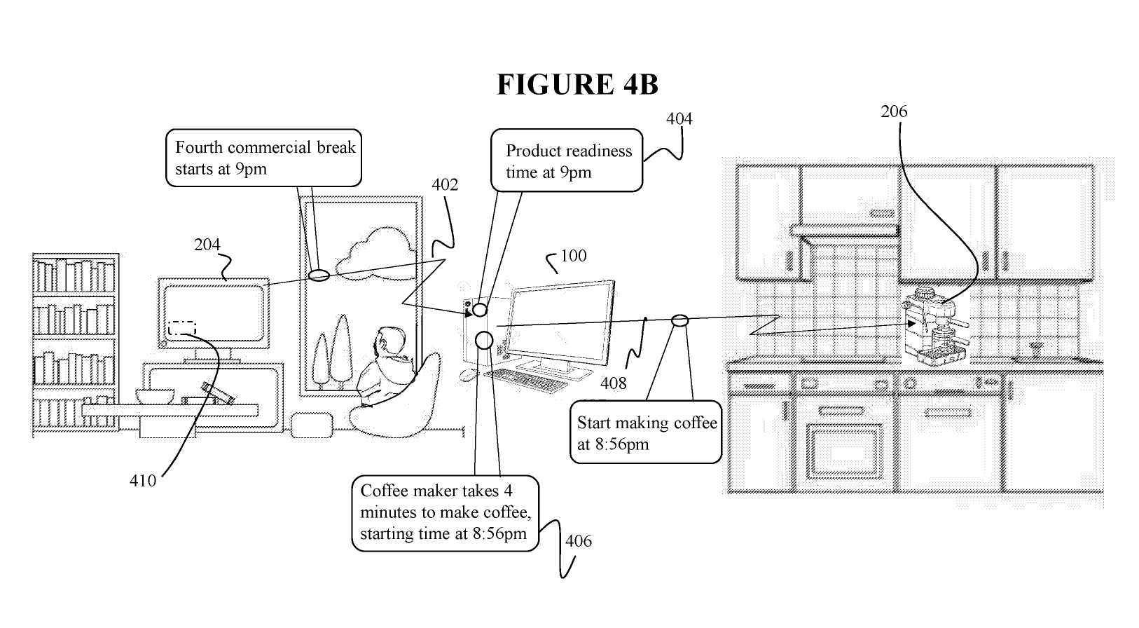

Reference is now additionally made to FIG. 3, which is a flow chart of an embodiment of a method for controlling a food preparing appliance using a suitable device, such as device 100 of FIG. 1, in a suitable system, such as system 200 of FIG. 2, according to an embodiment of the teachings herein, and to FIGS. 4A and 4B, which are schematic pictorial illustrations of steps of use of the device for remotely controlling a food preparing appliance, according to an embodiment of the teachings herein.

At an initial preparatory step, indicated by reference numeral 300 in FIG. 3, and illustrated in FIG. 4A, a user 400 defines system settings and/or user preferences for remote control of food preparing appliance 206 with respect to media content. Typically, the user defines the settings in the control module 100, for example via interaction with an input component of user interface 132. The system settings may include communication channels, communication protocols, and other settings required for correct function of the system 200 or of control module 100.

In FIG. 4A, user 400 uses user interface 132 to define a user preference requiring that the coffee maker prepare hot coffee which should be ready at the beginning of the fourth commercial break of every baseball match watched by the user, as indicated at reference numeral 401.

The settings and preferences defined by the user are stored in a storage medium, which may be storage medium 122 of control module 100, storage medium 246 of media content playing device 204, storage medium 266 of food preparing appliance 206, or external storage medium 208, provided that the settings are accessible to control module 100 for use thereby.

The user preferences provided by the user may relate to remote-controlled activation of the food preparing appliance, particularly with respect to a media content event.

Some of the defined user preferences may relate to a single specific remote-controlled activation of a food preparing appliance. For example, Josh is hosting friends for a superbowl party, and wants to have popcorn ready at the end of halftime. Josh does not know who will be hosting the next superbowl party, and as such does not want to define any long-term food-preparing preferences. As such, Josh may interact with the input components of user interface 132 of control module 100 and may define a rule requiring “have popcorn ready at the end of the halftime during superbowl 2016”.

Some of the defined user preferences may define activation rules to be applied at multiple remote-controlled activations of the food preparing appliance, or at each time the conditions defined by the user preference are met. For example, Michael likes to drink a hot cappuccino whenever he watches the evening news. He may define a user preference, via the user interface 132 of control module 100, requiring “have hot cappuccino ready at the end of the 10 pm news broadcast”. Such a condition would be met every time Michael would watch the 10 pm news broadcast, and as such would apply to multiple remote-controlled activations of the food preparing appliance.

In some embodiments, the defined user preferences are specific to an event related to playing of a media content item or to the content of a media content item. For example, the event may be starting playing the media content item, ending playing the media content item, pausing playing the media content item, resuming playing the media content item following pausing thereof, starting playing advertisements during the media content item, stopping playing advertisements during the media content item, appearance of a specific actor, actress, character, or location in the media content item, switching between scenes within the media content item, starting a song in a soundtrack of the media content item, ending a song in the soundtrack of the media content item, starting a specific segment in a soundtrack of the media content item, starting a break in a sports game forming the media content item, or ending a break in a sports game forming the media content item.

In some embodiments, the defined user preferences may be specific to a specific day, date, or time, for example defining that the coffee maker be remotely activated whenever the media content playing device plays the news broadcast after four pm on a weekend.

In some embodiments, the defined user preferences may be specific to a specific type of media content, for example that popcorn be made when a sports match is being played by the media content playing device.

In some embodiments, the defined user preferences may relate to a specific timing relative to the event. For example, the user may define a rule requiring hot water to be ready 10 minutes after the start of each commercial break.

In some embodiments, the defined user preferences may relate to characteristics of the media content. For example, the user may define a rule requiring tea with milk to be prepared at the end of every episode of a BBC series, or popcorn to be ready at the first commercial break of every thriller movie.

In some embodiments, the defined user preferences may relate to characteristics of the user. For example, the user may define a rule that coffee must be prepared at the beginning of every soccer game, but only if the user logged into the control module is ‘Dad’.

In some embodiments, the defined user preferences may relate to calendar events associated with the user. For example, the user may define a rule requiring popcorn to be prepared 30 minutes after the start of a basketball match, but only if the electronic calendar for that day includes an event entitled ‘basketball and beer with the guys’.

The following scenarios provide exemplary use cases, or situations that a user may encounter which may be suitable for using remote control of a food preparing appliance as described herein.
1. John and his friends get together to watch a baseball game every Sunday evening during baseball season. While watching the games, they enjoy drinking beer and munching on fresh popcorn, particularly during commercial breaks. When John's friends arrive at his house to watch the game, John approaches the control module 100, and defines user preferences requesting that popcorn should be ready at the beginning of the first commercial break in the game. The control module 100 identifies the event, and the desired readiness time, as being the beginning of the first commercial break, and sets the starting time of the popcorn machine, or food preparing appliance 106, to be prior to the beginning of the first commercial break (the event), so that the popcorn be ready at the requested time.
2. Elizabeth enjoys drinking tea during the intermission of a classical music concert, but does not like her tea scalding hot. As such, Elizabeth likes to prepare the tea 10 minutes before she wants to drink it, and to let it cool during those 10 minutes. Elizabeth uses the user interface of control module 100 to set a user preference rule requesting that whenever she is watching a classical music concert on television, or listening to a classical music concert on the radio, hot tea be prepared 10 minutes prior to the beginning of the intermission. The control module 100 identifies the event as being the beginning of the intermission in a classical music concert, and the desired readiness time to be ten minutes prior to the event. Knowing that Elizabeth's favorite kind of tea takes 5 minutes to brew, the control module sets the starting time of the tea brewing machine, or food preparing appliance 206, to be 15 minutes prior to the beginning of the intermission, so that by the time the intermission starts the tea is at the perfect temperature for Elizabeth to enjoy.
3. Alex and Louise like to eat toasted bread for breakfast while watching the morning news broadcast on FOX. However, they only start watching the news broadcast after the first three minutes have passed, as they do not like hearing about the overnight crimes. Alex has used control module 100 to set a user preference rule requesting that toasted bread be ready every morning three minutes after the beginning of the morning news broadcast on FOX. The control module 100 identifies the event as being the beginning of the morning news broadcast, and the desired readiness time to be three minutes after the event. Knowing that the bread toaster used by Alex and Louise only takes one minute to toast bread, the control module 100 sets the starting time of the bread toaster, or food preparing appliance 206, to be two minutes following the beginning of the news broadcast, so that the toast is ready just when Alex and Louise begin watching the news broadcast.
4. Every time Joanna sees a movie starring Juliette Binoche, she is reminded of the movie ‘Chocolat’ and has a craving for drinking hot chocolate with chili powder, as offered in that movie. Joanna noticed on the television schedule that the movie ‘The English Patient’ would be playing in a few minutes, and intends to watch it. Knowing she will have a craving for hot chocolate as soon as Juliette Binoche appears on the screen, Joanna uses control module 100 to request that hot chocolate with chili powder be prepared, so that it is ready when Juliette Binoche makes her first appearance in the movie. The control module 100 identifies the event, and the desired readiness time, as being the first appearance of Juliette Binoche in the movie ‘The English Patient’, and sets the starting time of the coffee machine preparing the hot chocolate, or food preparing appliance 206, to be prior to the event, so that the hot chocolate is ready for Joanna's craving to be fulfilled as soon as Juliette Binoche is seen on the screen.
5. Jake enjoys watching music reality TV shows, such as ‘American Idol’, in which the judges provide their scores to each of the competitors following their performance. Jake likes drinking iced coffee while listening to the performances, but does not enjoy all the introductory comments provided by the host and judges at the beginning of the show. Prior to beginning to watch a music reality TV show, Jake defines a user preference in control module 100 requesting that iced coffee including crushed ice be ready five minutes after the beginning of the show, so that it is ready in time for the first performance. Control module 100 identifies the event as being the beginning of the show, and the product readiness time to be three minutes after the beginning of the show. Additionally, control module 100 has information indicating that the iced coffee maker requires three minutes to crush the ice and prepare the iced coffee, and as such sets the starting time to be equal to the time of the event, so that the iced coffee is ready when Jake begins watching the performances.

At a second stage, following definition of user preferences, the media content playing device 204 communicates to the control module 100 a time of an event related to media content played thereby as seen at step 302 and in FIG. 4B. In a typical scenario, illustrated in FIG. 4B, the user 400 is watching the media content related to the event (but this is not always the case), which in the example of FIGS. 4A and 4B is a baseball match, and at step 300 the user had created some directive to the control module defining an event related to the media content and a required action related to the event or in response thereto.

In the example of FIG. 4B, the media content playing device 204 communicates the time at which the fourth commercial break of the baseball match is scheduled to begin to the control module 100, as indicated by arrow 402.

The time of the event may be defined by a remote operator, such as a cable service provider or a broadcast television service provider, or by the local system. For example, if the event is related to commercials, the time of the event would be defined by the operator if the commercials are inserted by the operator, or by the local system if the commercials are locally inserted. As another example, if the event is the appearance of a specific actor in the media content, and it is known that the actor appears 10 minutes after the start of the media content item, the time of the event is defined by the time at which the media content item begins to be played, as well as by the length of commercials inserted into the media content prior to the appearance of the actor.

It will be appreciated that in some embodiments, the media content playing device 204 communicates to the control module 100 information relating to the media content, and the time of the event is determined, by the control module 100, based on the received information. For example, in a case in which the event is the beginning of a specific song in the soundtrack of the media content, the information provided by media content playing device 204 may be that the song begins at minute 30 of the media content item, that the media content will begin to be played at 8:00 pm, and that no commercials are scheduled to be inserted in the media content, and the control module 100 would compute from the received information that the time of the event will be 8:30 pm.

In some embodiments, the time of the event is communicated to the control module 100 prior to occurrence of the event. In some embodiments, the time of the event is communicated to the control module 100 subsequently to the time of the event. For example, the user defined a rule requiring coffee to be ready 10 minutes after the beginning of a commercial break. The time of the event (time at which the commercial break begins) may be communicated to control module 100 a minute or two after the commercial break has begun, and due to the short amount of time required for preparation of coffee by the coffee maker, the coffee would still be ready as required.

In some embodiments, the event is related to a specific media content item, which is being played at the time of communicating the time of the event from the media content playing device 204 to the control module 100. In some embodiments, the event is related to a media content item, and the time of the event is communicated to the control module 100 prior to beginning playing of the media content item.

At step 304, based on the time of the event received from the media content playing device (step 302) and on the settings and/or rules defined by the user (step 300), the control module 100 electronically determines a product readiness time for a food product to be prepared by the food preparing appliance. In the example of FIG. 4B, the control module 100 computes the readiness time for the coffee to be at the time provided by the media content playing device as the start of the fourth commercial break, as indicated at reference numeral 404 in FIG. 4B.

In some embodiments, the product readiness time is determined to be substantially equal to the time of the event, as in the example of FIG. 4B. In some embodiments, the product readiness time is determined to be later than the time of the event, for example by a predetermined delay duration, which may be included in the settings defined by the user (step 300). In some embodiments, the product readiness time is determined to be earlier than the time of the event, for example by a predetermined preceding duration, which may be included in the settings defined by the user (step 300).

At step 306, the control module 100 uses the determined product readiness time (step 304), as well as information relating a duration required for preparation of the required food product by the food preparing appliance 206, to compute a starting time at which the food preparing appliance should begin operation, in order for the food product to be ready at the product readiness time.

In the example of FIG. 4B, control module 100 identifies that the coffee maker requires 4 minutes to prepare coffee as desired by the user, and thus computes the starting time to be 4 minutes prior to the product readiness time, as indicated by reference numeral 406 in FIG. 4B.

In some embodiments, the information relating to the duration required for preparation of food products by food preparing appliance 206 may be stored in a storage medium, such as storage medium 122 of the control module 100, or storage medium 266 of the food preparing appliance 206 or storage medium 208 which are accessible to control module 100 via a network. In some embodiments, the information may be obtained, for example via a network, when it is required for computing the starting time. For example, when the control module 100 computes the starting time required for preparing coffee in a coffee maker, it may access, via a network connection, specifications of the coffee maker in a website related to the coffee maker, and retrieve from there the information relating to the duration required for the preparation of coffee.

In some embodiments, the starting time is computed to be substantially equal to the time of the event. In some embodiments, the starting time is computed to be later than the time of the event by a predetermined delay duration. In some embodiments, such as the one illustrated in FIG. 4B, the starting time is computed to be earlier than the time of the event by a predetermined preceding duration.

At step 308, which typically occurs subsequently to receipt by the control module 100 of the time of the event (step 302), to determination of the product readiness time (step 304), and/or to computation of the starting time (step 306), the control module may query whether or not there are sufficient raw materials in the food preparing appliance 206 for preparation of the required food product. The query may be directed to the processor 264 of the food preparing appliance 206, which may determine the quantity of raw materials available to the food preparing appliance, for example based on signals received from sensors associated therewith.

If the control module 100 determines that there are insufficient raw materials available to the food preparing appliance 206 for preparation of the required food product, at step 310 the user may be alerted to refill the raw materials available to the food preparing appliance, for example by providing a visual output or an audio output to the user using the user interface of the media content playing device 204. For example, a message may flash at the bottom of the screen while the user is watching media content, alerting the user to the need to refill coffee beans in the coffee machine. This alert may be repeated until the user makes additional raw materials available to the food preparing appliance, or until the computed starting time (step 306) has passed, as seen at step 312.

As seen at step 314, if the computed starting time has passed, and the user has not made sufficient quantities of raw materials accessible to the food preparing appliance, the control module 100 may optionally notify the user that the required food product will not be ready in accordance with the user settings and/or rules. For example, the control module may communicate to the media content playing device 204 a notification to be provided to the user via the user interface thereof, for example as a message flashing on the display screen of the media content playing device.

It will be appreciated that some food preparing appliances automatically receive a continuous supply of raw material, and as such always have a sufficient supply of raw materials. For example, a water boiler may be connected to the tap for water supply, and thus has an unlimited supply of cold water for boiling. In these situations, steps 308 to 314 may be obviated.

Otherwise, if at step 308 the control module 100 determines that there are sufficient raw materials available for the food preparing appliance, if the user has refilled the quantity of raw materials following receipt of the alert at step 310, or if the appliance has a continuous supply of the required raw materials, at step 316 control module 100 remotely sets the food preparing appliance 206 to begin operation at the starting time. In some embodiments, the control module 100 sets the food preparing appliance by sending a command, from control module 100 to food preparing appliance 206, via network 207, the command causing the food preparing appliance to start operation at the starting time.

In the example of FIG. 4B, control module 100 sends a command to the coffee maker 206 to begin preparation of coffee at the calculated starting time, as indicated by arrow 408.

In some embodiments, the control module 100 sends the command immediately following computing the starting time. In some embodiments, the control module 100 sends the command immediately prior to the starting time.

In some embodiments, following setting the food preparing appliance 206 to prepare the food product for the product readiness time, or following completion of preparation of the food product, the control module 100 may notify the user that the food product will be or is ready, as seen at step 318. In some embodiments, the notification may be provided via user interface 246 of the media content playing device 204, such as for example by displaying a message on a display screen associated with the media content playing device. In the example illustrated in FIG. 4B, a message 410, indicating the time at which the coffee will be ready, flashes at the bottom corner of a screen associated with the media content playing device 204.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. In a system including a control module in communication with a media content playing device and with a food-preparing appliance operable to prepare a food product, a method for controlling the food-preparing appliance comprising the steps of:
a. obtaining, by communication between said control module and said media content playing device, a time of an event related to media content played by the media content playing device;
b. electronically determining by said control module a product readiness time for the food product based at least on the time of said event;
c. setting the food preparing appliance to begin operation at a time such that said food product be ready at said product readiness time.

2. The method of claim 1, wherein said setting includes:
a. based on said product readiness time, computing a starting time at which said food-preparing appliance should begin operation; and
b. setting said food-preparing appliance to begin operation at said starting time.

3. The method of claim 2, wherein said setting said food-preparing appliance to begin operation at said starting time includes sending a command, from said control module to said food-preparing appliance, said command causing said food-preparing appliance to start operation at said starting time.

4. The method of claim 3, wherein said sending said command takes place immediately following said computing said starting time.

5. The method of claim 3, wherein said sending said command takes place immediately prior to said starting time.

6. The method of claim 2, wherein said computing said starting time comprises computing said starting time to be substantially equal to said time of said event.

7. The method of claim 2, wherein said computing said starting time comprises computing said starting time to be later than said time of said event by a predetermined delay duration.

8. The method of claim 2, wherein said computing said starting time comprises computing said starting time to be earlier than said time of said event by a predetermined preceding duration.

9. The method of claim 1, wherein said obtaining includes:
a. receiving from said media content playing device information relating to said media content; and
b. determining said time of said event based on said received information.

10. The method of claim 1, wherein said determining comprises determining said product readiness time based on said time of said event and on previously stored user preferences accessible to said control module.

11. The method of claim 1, wherein said determining comprises determining said product readiness time to be substantially equal to said time of said event.

12. The method of claim 1, wherein said determining comprises determining said product readiness time to be later than said time of said event by a predetermined delay duration.

13. The method of claim 1, wherein said determining comprises determining said product readiness time to be earlier than said time of said event by a predetermined preceding duration.

14. The method of claim 1, wherein said obtaining said time of said event takes place subsequently to occurrence of said event.

15. The method of claim 1, wherein said obtaining said time of said event takes place before occurrence of said event.

16. The method of claim 1, wherein said event is related to a media content item forming part of said media content, and is selected from the group consisting of:
a. a beginning of playing of said media content item;
b. an ending of playing said media content item;
c. pausing playing of said media content item;
d. resuming playing said media content item following pausing thereof;
e. starting playing advertisements during said media content item;
f. stopping playing advertisements during said media content item;
g. appearance of at least one of a specific actor, actress, character, or location in said media content item;
h. switching between scenes within said media content item;
i. starting a song in a soundtrack of said media content item;
j. ending a song in said soundtrack of said media content item;
k. starting a break in a sports game forming said media content item; and
l. ending a break in said sports game forming said media content item.

17. The method of claim 1, wherein said event is related to a media content item forming part of said media content, said media content item being played at a time of said obtaining said time of said event.

18. The method of claim 1, wherein said event is related to a media content item forming part of said media content, wherein said media content item is scheduled to be played at a time following a time of said obtaining said time of said event.

19. A device for controlling a food preparing appliance, the device being in communication with the food preparing appliance and with a media content playing device, said device including:
a. a processor; and
b. a non-transitory computer readable storage medium for instructions execution by the processor, the non-transitory computer readable storage medium having stored:
i. instructions to obtain, by communication with said media content playing device, a time of an event related to media content played by said media content playing device;
ii. instructions to electronically determine a product readiness time for a food product based at least on the time of said event; and
iii. instructions to set the food preparing appliance to begin operation at a time such that said food product be ready at said product readiness time.

20. The device of claim 19, further in communication with a non-transitory computer readable storage medium having user preferences stored therein, said non-transitory computer readable storage medium having stored instructions to determine said product readiness time based on said time of said event and on said user preferences.
